(19) United States
(12) Patent Application Publication
(10) Pub. No.: US 2012/0315459 A1
(43) Pub. Date: Dec. 13, 2012

(54) CARBON NANOTUBE SHEET AND PROCESS FOR PRODUCTION THEREOF

(76) Inventors: Bunshi Fugetsu, Hokkaido (JP); Takeru Yajima, Hokuto-shi (JP); Toshiyuki Abe, Hokuto-shi (JP); Toru Sakai, Hokuto-shi (JP)

(21) Appl. No.: 13/578,879

(22) PCT Filed: Feb. 15, 2011
(86) PCT No.: PCT/JP2011/053104

§ 371 Date: Aug. 14, 2012

(30) Foreign Application Priority Data
Feb. 15, 2010 (JP) 2010-030691

(51) Int. Cl. B32B 27/04; B29C 39/10; B82Y 30/00; B82Y 40/00

(52) U.S. Cl. 428/299.1; 264/255; 977/742; 977/897

(57) ABSTRACT

A carbon nanotube sheet of the present invention includes carbon nanotubes and a polymeric material, wherein the carbon nanotubes are present in an isolated state, the axis directions of the carbon nanotubes are aligned m a thickness direction of the carbon nanotube sheet, and the space between the carbon nanotubes is filled with the polymeric material.

### TECHNICAL FIELD

The present invention relates to a carbon nanotube sheet in which vertically aligned carbon nanotubes are formed into a sheet, and a method for producing the same.

Priority is claimed on Japanese Patent Application No. 2010-030691, filed Feb. 15, 2010, the content of which is incorporated herein by reference.

### BACKGROUND ART

A carbon nanotube (CNT) is a substance of a hollow structure measuring about 0.7 to 100 nm in diameter and about several μm to about several tens of mm in length, in which a single wall or multi wall graphene sheet of carbon atoms arranged in a hexagonal network is rounded in a cylindrical shape. The carbon nanotube has not only excellent thermal and chemical stabilities as well as mechanical strength, but also properties which vary depending on the way of winding and the thickness of a tube, and thus it is expected as future mechanical and functional materials.

However, the carbon nanotube has high content of atoms constituting a surface among atoms constituting the carbon nanotube. For example, in a single wall carbon nanotube, alls constituent atoms are surface atom. Therefore, carbon nanotubes are likely to aggregate due to Van der Waals forces between adjacent carbon nanotubes, and usually exist in a state where a plurality of carbon nanotubes form a bundle or form aggregates. The high aggregation properties limit possibility of application of carbon nanotubes, each having excellent characteristics alone.

There has been known a method in which carbon nanotubes are vertically aligned on a substrate of silicon (Si), silicon oxide (SiO₂) or the like thereby to produce a sheet made of a carbon nanotubes (Patent Literatures 1 to 4). In the thus produced aligned carbon nanotube sheet, carbon nanotubes are arranged in a state where the axis directions thereof are aligned in a thickness direction of the sheet. Therefore, conductivity and thermal conductivity exhibit high anisotropy, and various applications are expected. This production method also has an advantage capable of producing a carbon nanotube sheet having a desired thickness since it enables uniform diameter and length of carbon nanotubes. Also in a carbon nanotube sheet, carbon nanotubes are aligned in the form of a bundle on a substrate.

It is difficult to peel a carbon nanotube sheet from a substrate while maintaining a state as it is. Therefore, commonly, a carbon nanotube sheet is peeled by applying to an adhesive coated sheet, or a carbon nanotube sheet is peeled after a resin heated to a softening point temperature or higher is pressed against the carbon nanotube and the carbon nanotube is fixed by applying a large pressure.

Patent Literature 1 proposes a method in which carbon nanotubes vertically aligned on a substrate is impregnated with a polymeric material.

Patent Literature 2 proposes a method in which a substrate on which carbon nanotubes are vertically aligned is pressed against a heated conductive polymer under high pressure, whereby, carbon nanotubes are implanted to the conductive polymer and carbon nanotubes on the substrate are transferred to the conductive polymer.

Patent Literature 3 proposes a method in which a substrate on which carbon nanotubes are vertically aligned is pressed against a conductive adhesive thereby to transfer carbon nanotubes to the conductive adhesive.

Patent Literature 4 proposes a method in which the space between carbon nanotubes vertically aligned on a substrate (current collector) is filled with a monomer, followed by polymerization and further carbonization thereby to produce an electrode in which a sheet obtained by filling a carbide into the space between carbon nanotubes is formed on a substrate.

### CITATION LIST

### Patent Literature

### [Patent Literature 1]

Japanese Unexamined Patent Application, First Publication No. 2006-069165

### [Patent Literature 2]

Japanese Unexamined Patent Application, First Publication No. 2004-030926

### [Patent Literature 3]

Japanese Unexamined Patent Application, First Publication No. 2004-127737

### [Patent Literature 4]

Japanese Unexamined Patent Application, First Publication No. 2007-035811

### [Patent Literature 5]

Japanese Unexamined Patent Application, First Publication No. 2007-039623

### SUMMARY OF INVENTION

### Technical Problem

However, carbon nanotubes vertically aligned on a substrate generally forms a bundle, and a polymeric material having high viscosity such as a resin or a rubber cannot penetrate into a bundle of carbon nanotubes. In a practicable carbon nanotube sheet, it is necessary that carbon nanotubes are formed on a substrate in sufficient high density. In this case, because of smaller distance between bundles, a polymeric material having high viscosity such as a resin or a rubber cannot sufficiently penetrate into the space between bundles even when viscosity is decreased.

Accordingly, according to the method proposed in Patent Literature 1, a polymeric material cannot sufficiently penetrate into a bundle and the space between bundles in carbon nanotubes vertically aligned on a substrate in sufficient high density, and thus it is impossible that a polymeric material is uniformly filled into a carbon nanotube sheet and carbon nanotubes are formed into a sheet thereby to fix carbon nanotubes. It is also impossible to peel a carbon nanotube sheet while retaining a state of the carbon nanotube sheet. Therefore, there was a problem that it is impossible to utilize as a carbon nanotube sheet.

Similarly, according to the method proposed in Patent Literature 2, a polymeric material having high viscosity such as a resin or a rubber cannot sufficiently penetrate into a bundle and the space between bundles in carbon nanotubes vertically aligned on a substrate in sufficient high density, and thus it is impossible that a conductive polymer is filled into a carbon nanotube sheet thereby to fix carbon nanotubes. Therefore, there was a problem that it is substantially impossible to transfer.

Similarly, according to the method proposed in Patent Literature 3, a polymeric material cannot sufficiently penetrate into a bundle and the space between bundles in carbon nanotubes vertically aligned on a substrate in sufficient high density. Furthermore, it is necessary for carbon nanotubes to have uniform height with satisfactory accuracy. There is also a problem that only one end of carbon nanotubes is bonded in a carbon nanotube sheet after transfer, and carbon nanotubes per se have no sheet structure and are in an unstable self-standing state, and thus failing to endure practical use as a carbon nanotube sheet in a state as it is. In addition, it is impossible to obtain the expected anisotropy of conductivity and thermal conductivity.

The method proposed in Patent Literature 4 includes the step of impregnating with a monomer. However, similar to Patent Literatures 1 to 3, carbon nanotubes vertically aligned on a substrate forms a bundle, and even a monomer cannot penetrate into the bundle. In contrast, while the monomer can penetrate into the space between handles, it is difficult to penetrate into the space between bundled carbon nanotubes. Therefore, there was a problem that a carbon nanotube sheet cannot be produced in a state where carbon nanotubes are uniformly arranged. Accordingly, there was a problem that conductivity and thermal conductivity in a plane direction of a carbon nanotube sheet are unstable and characteristics thereof are not stable, and also stable anisotropy cannot be obtained.

The present invention has been made in view of the above circumstances and an object thereof is to provide a carbon nanotube sheet in which a polymeric material is filled in a state where individual carbon nanotubes are isolated, and in-plane physical properties have ultimate uniformity, and physical properties of a single carbon nanotube can be utilized; and a method for producing the same.

### Solution to Problem

The present inventors have intensively studied so as to achieve the above object, and thus succeeding in the production of a carbon nanotube sheet in which individual carbon nanotubes are fixed by a resin while being in an isolated state, by vertically aligning the group of carbon nanotubes, which is generally in the form of a bundle, on a substrate, applying isolation and dispersion technologies in a solution (for example, Patent Literature 5) thereby to disentangle aggregates (bundle) of the carbon nanotubes, resulting in individual carbon nanotubes in an isolated state, impregnating the space between the carbon nanotubes in the isolated state with a monomer, and polymerizing the monomer. In addition, the present inventors have conceived of an epoch-making idea of producing a carbon nanotube sheet having ultimate uniformity fixed by a resin, and thus completing the present invention.

In order to achieve the above object, the present invention employs the following means.

(1) A carbon nanotube sheet comprising carbon nanotubes and a polymeric material, wherein

the carbon nanotubes are present in an isolated state,

the axis directions of the carbon nanotubes are aligned in a thickness direction of the carbon nanotube sheet, and

the space between the carbon nanotubes is filed with the polymeric material.

(2) The carbon nanotube sheet according to (1), wherein the end of the carbon nanotube protrudes from a front surface and/or a rear surface of the carbon nanotube sheet.
(3) The carbon nanotube sheet according to (1), wherein, the end of the carbon nanotube is embedded in the polymeric material, and the carbon nanotube does not protrude from any of front and rear surfaces of the carbon nanotube sheet.
(4) The carbon nanotube sheet according to any one of (1) to (3), wherein the occupancy of a carbon nanotube in a plane direction of the carbon nanotube sheet is 0.001% or more.
(5) The carbon nanotube sheet according to any one of (1) to (4), wherein a ratio ρₗ/ρₜ of volume resistivity (ρₜ) in a thickness direction to volume resistivity (ρₗ) in a plane direction of the carbon nanotube sheet is 50 or more.
(6) The carbon nanotube sheet according to any one of (1) to (5), wherein the carbon nanotube has a length of 10 μm or more.
(7) The carbon nanotube sheet according to (6), wherein the thickness of the polymeric material filled accounts for 0.5% to 150% of the length of the carbon nanotube.
(8) A method for producing a carbon nanotube sheet, which comprises:

immersing an aligned carbon nanotube base material including a substrate, and the group of carbon nanotubes in which a plurality of carbon nanotubes are vertically aligned thereby to form a bundle to the substrate, in an amphiphilic molecule-containing solution;

drying the immersed aligned carbon nanotube base material;

impregnating the dried aligned carbon nanotube base material with a monomer;

polymerizing the monomer thereby to form a carbon nanotube sheet, in which the space between carbon nanotubes is filled with the polymer, on the substrate; and

peeling the carbon nanotube sheet front the substrate.

(9) A method for producing a carbon nanotube sheet, which comprises:

immersing an aligned carbon nanotube base material including a substrate, and the group of carbon nanotubes in which a plurality of carbon nanotubes are vertically aligned thereby to form a handle to the substrate, in an amphiphilic molecule-containing solution;

washing the aligned carbon nanotube base material with a washing solvent;

impregnating the aligned carbon nanotube base material, which is made to be present in a vertically downward state, with a monomer;

polymerizing the monomer thereby to form a carbon nanotube sheet on the substrate; and

peeling the carbon nanotube sheet from the substrate; wherein

the aligned carbon nanotube base material is prevented from drying in a range from immersion in the amphiphilic molecule-containing solution to impregnation with the monomer.

(10) The method for producing a carbon nanotube sheet according to (8) or (9), wherein the amphiphilic molecule is selected from the group consisting of a polymer of 2-methacryloyloxyethylphosphorylcholine, polypeptides, 3-(N,N-dimethylstearylammonio)propane sulfonate, 3-(N,N-dimethylmyristylammonio) propane sulfonate, 3-[(3-cholamidepropyl)dimethylammonio]-1propane sulfonate (CHAPS), 3-[(3-cholamidepropyl)dimethylammonio]-2-hydroxypropane sulfonate (CHAPSO), n-dodecyl-N,N′-dimethyl-3-ammonio-1-propane sulfonate, n-hexadecyl-N,N′-dimethyl-3-ammonio-1-propane sulfonate, n-octylphosphocholine, n-dodecylphosphocholine, n-tetradecylphosphocholine, n-hexadecylphosphocholine, dimethylalkylbetaine, perfluoroalkylbetaine and lecithin.
(11) The method for producing a carbon nanotube sheet according to any one of (8) to (10) wherein the occupancy of vertically aligned carbon nanotubes in a plane direction of the aligned carbon nanotube base material is 0.001% or more.

In the method for producing a carbon nanotube sheet of the present invention, for example, carbon nanotubes vertically aligned on a substrate are immersed in a solution prepared by mixing a water-soluble solvent with amphiphilic molecules of an amphiphilic surfactant, as they are, whereby, carbon nanotubes are made to be present in an isolated state while being aligned on a substrate. Then, the water-soluble solvent is dried and vaporized thereby to form a state where amphiphilic molecules fill the space between isolated aligned carbon nanotubes. The group of aligned carbon nanotubes in this state is immersed in a monomer and a polymer sheet is formed by performing polymerization and curing (crosslinking) treatment, followed by peeling from a substrate to obtain a carbon nanotube sheet.

The phrase “carbon nanotubes are present in an isolated state” in the present invention includes not only the case where all carbon nanotubes are isolated, but also the case where at least 30% or more of carbon nanotubes are isolated.

The phrase “the axis directions of the carbon nanotubes are aligned in a thickness direction of the carbon nanotube sheet” in the present invention means that most (typically 50 number % or more) of carbon nanotubes in a carbon nanotube sheet are vertically aligned to a substrate surface. Vertical aligning includes a direction generally orthogonal to a surface of a base material, and a direction slightly inclined which can be considered to be identical to the direction.

The phrase “vertically aligned to a substrate” in the present invention is also identical to the phrase “the axis directions of the carbon nanotubes are aligned in a thickness direction of the carbon nanotube sheet”.

### Advantageous Effects of Invention

The carbon nanotube sheet of the present invention is configured in a manner such that the carbon nanotubes are present in an isolated state, the axis directions thereof are aligned in a thickness direction of the carbon nanotube sheet, and the space between the carbon nanotubes is filled with the polymeric material. Therefore, an aligned state is stable and self-standing, and carbon nanotubes are not removed. Accordingly, it is possible to make use of a sheet as it is, and to press and stretch a carbon nanotube sheet.

Since a distance between carbon nanotubes varies by applying a pressure and applying tensile stress to a carbon nanotube sheet, the carbon nanotube sheet can be applied to a sensor by combining the measurement of a resistance value with the measurement of a micro-current value.

Furthermore, since carbon nanotubes in a vertically aligned state are present in an isolated state, the carbon nanotube sheet has stable performances with respect to physical properties such as conductivity and thermal conductivity per unit area, or anisotropy of them in a plane direction versus a thickness direction.

According to the method for producing a carbon nanotube sheet of the present invention, since physical properties in a thickness direction of the thus produced carbon nanotube sheet are determined by integration of those of a single carbon nanotube, it is possible to easily obtain a carbon nanotube sheet having desired physical properties in a thickness direction with high accuracy by selecting the size of a sheet area. For example, since electric conductivity in a thickness direction is determined by integration of electric conductivity of a single carbon nanotube, it is possible to obtain a carbon nanotube sheet having an electric conductivity in a thickness direction controlled by the size of a sheet area of the carbon nanotube sheet.

In the step of immersing an aligned carbon nanotube base material in an amphiphilic molecule-containing solution, control of conditions such as immersion time enables all carbon nanotubes on a substrate to be present in an isolated state, and also enables only a part of carbon nanotubes to be present in an isolated state and enables a bundle state to remain. Whereby, it is possible to control physical properties of a carbon nanotube sheet.

Control of conditions of the step of impregnating an aligned carbon nanotube base material with a monomer enables the end of a carbon nanotube to protrude from a front surface and/or a rear surface of a sheet, and also enables a carbon nanotube to embed in a polymeric material thereby to prevent the carbon nanotube from protruding from any of a front surface and a rear surface of the sheet. When a carbon nanotube is embedded in a polymeric material, for example, an end face of the carbon nanotube at a substrate side may be peeled, followed by formation of a polymeric material layer on the face.

In the production stage of an aligned carbon nanotube base material, it is possible to produce a carbon nanotube sheet in which the occupancy of a carbon nanotube in a plane direction of a substrate is desired occupancy, for example, 0.001% or more by adjusting the occupancy of a carbon nanotube in a plane direction of a substrate.

In the production stage of an aligned carbon nanotube base material, it is possible to produce a carbon nanotube sheet in which anisotropy of volume resistivity of a carbon nanotube sheet (i.e. a ratio ρₗ/ρₜ of volume resistivity (ρₜ) in a thickness direction to volume resistivity (ρₗ) in a plane direction of the carbon nanotube sheet) has desired magnitude, for example, 50 or more, by adjusting the length of a carbon nanotube, and also controlling conditions of the step of impregnating an aligned carbon nanotube base material with a monomer thereby to adjust a distance between individual carbon nanotubes.

In the production stage of an aligned carbon nanotube base material, it is possible to produce a carbon nanotube sheet made of carbon nanotubes having desired length, for example, 10 μm or more, by using long carbon nanotubes.

In the production stage of an aligned carbon nanotube base material, it is possible to produce a carbon nanotube sheet which is a thick sheet and is also filled with a polymeric material having desired thickness, for example, a carbon nanotube sheet in which the carbon nanotube has a length of 10 μm or more, and also the thickness of the polymeric material filled accounts for 0.5% to 150% of the length of the carbon nanotube, by using along carbon nanotube, and also controlling conditions of the step of impregnating an aligned carbon nanotube base material with a monomer thereby to adjust filling thickness of a polymeric material.

### BRIEF DESCRIPTION OF DRAWINGS

FIG. 1A is a schematic diagram describing the principle of isolated dispersion of carbon nanotubes in a solution.

FIG. 1B is a schematic diagram describing the principle of isolated dispersion of carbon nanotubes in a solution.

FIG. 1C is a schematic diagram describing the principle of isolated dispersion of carbon nanotubes in a solution.

FIG. 2A is a photograph of a carbon nanotube sheet of the present invention.

FIG. 2B is a photograph of a carbon nanotube sheet of the present invention.

FIG. 3A is an electron micrograph (top view) of a carbon nanotube sheer of the present invention.

FIG. 3B is an electron micrograph (top view) of a carbon nanotube sheet of the present invention.

FIG. 3C is an electron micrograph (top view) of a carbon nanotube sheet of the present invention.

FIG. 3D is an electron micrograph (top view) of a carbon nanotube sheet of the present invention.

FIG. 4 is an electron micrograph (top view) of a conventional carbon nanotube sheet.

FIG. 5A is an electron micrograph (cross-sectional view) of a carbon nanotube sheet of the present invention.

FIG. 5B is an electron micrograph (cross-sectional view) of a carbon nanotube sheet of the present invention.

FIG. 5C is an electron micrograph (top view) of a carbon nanotube sheet of the present invention.

### DESCRIPTION OF EMBODIMENTS

A carbon nanotube sheet as an embodiment to which the present invention is applied, and a method for producing the same will be described in detail below.

### [First Method for Production of Carbon Nanotube Sheet]

### <Step of Producing Aligned Carbon Nanotube Base Material>

First, an aligned carbon nanotube base material, in which the group of carbon nanotubes in which a plurality of carbon nanotubes are vertically aligned in the form of a bundle is provided on a substrate, is produced.

There is no particular limitation on the method in which a plurality of carbon nanotubes are vertically aligned in the form of a bundle on a substrate, and it is possible to use a known method.

Specifically, there are a method in which are discharge is generated between carbon electrodes, followed by growth on a cathode surface of an electrode for discharge (are discharge method), a method in which heating and sublimation are performed by irradiation of silicon carbide with laser beam (laser vaporization), a method in which hydrocarbon is carbonized in a vapor phase under a reducing atmosphere using a transition metal-based catalyst (chemical vapor deposition method: CVD method), thermal decomposition method, and a method utilizing plasma discharge. It is possible to suitably use, as the method in which a plurality of carbon nanotubes are vertically aligned in the form of a bundle on a substrate, a chemical vapor deposition method (CVD method).

It is possible to produce an aligned carbon nanotube base material including a substrate, and the group of carbon nanotubes in which a plurality of carbon nanotubes, each having a diameter of about 10 to 40 nm, are vertically aligned in the form of a bundle is provided to the substrate by applying, as the chemical vapor deposition method (CVD method), for example, a common chemical vapor deposition method (CVD method) on a film formed by applying a solution containing a complex of metal such as nickel, cobalt or iron on at least one surface of a substrate (silicon substrate) and heating the solution, or a film formed by implanting with cluster beam, using an acetylene gas.

It is possible to adjust the length of an aligned carbon nanotube on an aligned carbon nanotube base material by the addition amount of raw materials, synthesis pressure and CVD reaction time. The length of the aligned carbon nanotube can be increased to several mm by increasing the CVD reaction time.

The thickness of one aligned carbon nanotube constituting an aligned carbon nanotube base material can be controlled by the thickness of a catalyst film to be formed on a substrate. The particle diameter of a catalyst can be decreased by thinning the catalyst film, and thus the diameter of an aligned carbon nanotube formed by a CVD method decreases. In contrast, the particle diameter of a catalyst can be increased by thickening the catalyst film, and thus the diameter of an aligned carbon nanotube increases.

The number of carbon nanotubes per unit area can be increased while growing by uniformly controlling the particle diameter of a catalyst and densely disposing the catalyst, an aligned carbon nanotube base material can be obtained in high density.

More specific method for producing an aligned carbon nanotube base material will be shown below.

First, catalyst particles are formed on a substrate and a carbon nanotube is grown from a raw gas in a high temperature atmosphere using catalyst particles as nuclei.

The substrate may be a substrate which support catalyst particles and is preferably made of a material having smoothness which does not present a movement when the catalyst is fluidized and formed into particles. Particularly, a crystalline silicon, substrate is a material which is most easy to utilize from the viewpoint of smoothness, price and heat resistance. The substrate is desirably made of a material which has low reactivity with catalyst metal. In the case of a silicon substrate, since a compound is formed, a surface is desirably subjected to an oxidation treatment or a nitriding treatment. It is desired to use a substrate after metal oxide having low reactivity, such as alumina was formed on a surface and then a catalyst metal film was formed. The substrate includes, for example, a substrate including an oxide film (SiO₂) formed on a surface of a crystalline silicon substrate, and a substrate including a nitride film (Si₃N₄) formed thereon.

Examples of catalyst particles include metal particles made of nickel, cobalt, iron and the like.

A solution of a compound of these metals or a complex thereof is applied on a substrate by a spin coater, a spray, a bar coater or an ink jet, or implanted to a substrate by cluster beam. Then, the solution is dried and is optionally heated to form a film. The thickness of this film is from about 0.4 to 100 nm, and preferably from about 0.5 to 10 nm. When the thickness is more than 10 nm, it becomes difficult to form into particles by heating at about 700° C.

Then, when this film is heated, preferably under reduced pressure or under a non-oxidative atmosphere to a temperature of 500° C. to 1,000° C., and preferably 650 to 800° C., catalyst particles each having a diameter of about 0.4 to 50 nm are formed. When catalyst particles are formed and a particle diameter is made uniform in such a manner, the carbon nanotube is imparted with high density.

As a raw gas of the carbon nanotube, aliphatic hydrocarbons such as acetylene, methane and ethylene are appropriately used. Among these, an acetylene gas is preferred, and an ultra high purity acetylene gas having an acetylene concentration of 99.9999% is more preferred. When a raw gas having higher purity is used, the obtained carbon nanotube has more satisfactory quality. In the case of acetylene, a carbon nanotube of multi wall structure having a thickness of 0.5 to 40 nm is aligned and grown from catalyst particles, as nuclei, in a given direction vertical to a substrate to form brush-shaped carbon nanotubes

The temperature at which a carbon nanotube is formed in the above chemical vapor deposition method (CVD method) is from 50° C. to 1000° C., and preferably from 650 to 800° C.

The steps for the production of an aligned carbon nanotube base material can be performed by the following procedures.

### <Step of Immersing in Amphiphilic Molecule-Containing Solution>

First, a description will be made on the principle in which amphiphilic molecules open a carbon nanotube bundle in a dispersion to cause isolated dispersion of the individual carbon nanotubes.

Amphiphilic molecules adhere to at least a part of a carbon nanotube constituting a plurality of carbon nanotube bundles. Amphiphilic molecules adhered to the carbon nanotube constituting one carbon nanotube bundle among a plurality of carbon nanotube bundles, and amphiphilic molecules adhered to a carbon nanotube constituting adjacent other carbon nanotube bundles electrically attract each other thereby to cause isolated dispersion, of the respective carbon nanotubes constituting a carbon nanotube bundle.

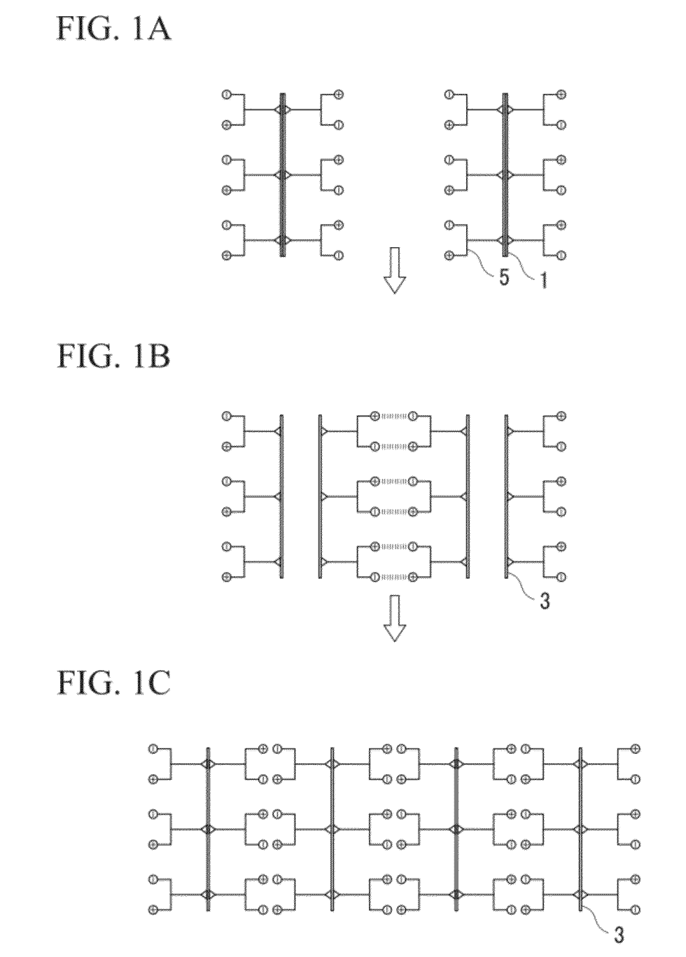

A description will be made in detail with reference to FIG. 1A. to FIG. 1C.

Amphiphilic molecules have positive and negative charges, and these molecules form self-assembled zwitterionic monolayer (hereinafter abbreviated to “SAZM”) on a surface of a carbon nanotube bundle.

SAZM covering a carbon nanotube bundle tends to be electrostatically bonded to SAZM covering the other carbon nanotube bundle by a strong electrical interaction between dipoles. When the respective carbon nanotube bundles in a mixture attract each other by an electrostatic force, peeling of the respective carbon nanotubes constituting a carbon nanotube bundle occurs and thus a new surface of a carbon nanotube bundle is exposed. Newly exposed surface is newly covered with SAZM. Since the above-mentioned reaction is repeated until carbon nanotubes constituting the carbon nanotube bundle are completely isolated and dispersed, carbon nanotubes are completely isolated and dispersed, finally.

When a carbon nanotube bundle 1, an amphiphilic molecule 5 and a stabilizer are mixed together, the amphiphilic molecule 5 is first self-assembled into a dimer or a tetramer by an electric attraction between amphiphilic molecules. At this time, the stabilizer forms a hydrogen bond, together with a hydrophobic moiety of the amphiphilic molecule 5, and thus making a bond between amphiphilic molecules constituting a dimer or a tetramer stable. The stabilizer may be absent, and therefore it is not shown herein.

Next, these SAZM constituent elements (dimer or tetramer of amphiphilic molecule) adhere to a surface of a carbon nanotube bundle 1 and associate between constituent elements to form SAZM on a surface of the carbon nanotube bundle 1 (FIG. 1A). At this time, when regions with the same polarity approach each other between adjacent amphiphilic molecules 5, a repulsive force is generated. Therefore, the amphiphilic molecule 5 constitutes SAZM such that positive charge and negative charge alternately exist, as shown in FIG. 1A to FIG. 1C.

SAZM which covers the carbon nanotube bundle 1 is electrostatically bond with SAZM which covers the other carbon nanotube bundle by a strong electrical interaction between dipoles. Such an electrical interaction between dipoles easily occurs, and it is sufficient to be left to stand. At this time, the respective carbon nanotube bundles attract each other by the electrostatic force, whereby, peeling of the respective carbon nanotubes 3 constituting the carbon nanotube bundle 1 occurs and thus carbon nanotubes including amphiphilic molecules adsorbed thereon are exposed (FIG. 1B).

This newly exposed surface is newly coated with an amphiphilic molecule 5. Since the above-mentioned reaction is repeated until carbon nanotubes constituting the carbon nanotube bundle are completely isolated and dispersed, carbon nanotubes 3 are completely isolated and dispersed by the amphiphilic molecule 5 (FIG. 1C).

In the present invention, it is possible to suitably use, as an amphiphilic molecule-containing solution which opens a carbon nanotube bundle aligned on an aligned carbon nanotube base material, a solution containing an amphiphilic molecule which is used as a dispersing agent capable of converting carbon nanotubes existing in a bundle state into an isolated dispersion state in the solution. There is no particular limitation on the amphiphilic molecule, and it is possible to selected from amphiphilic polymers such as a polymer of 2-methacryloyloxyethylphosphorylcholine and polypeptides; and amphiphilic polymers and amphiphilic surfactants, such as 3-(N,N-dimethylstearylammonio)propane sulfonate, 3-(N,N-dimethylmyristylammonio)propane sulfonate, 3-[(3-clolamidepropyl)dimethylammonio]-1-propane sulfonate (CHAPS), 3-[(3-cholamidepropyl)dimethylammonio]-2-hydroxypropane sulfonate (CHAPSO), n-dodecyl-N-N′-dimethyl-3-ammonio-1-propane sulfonate, n-hexadecyl-N,N′-dimethyl-3-ammonio-1-propane sulfonate, n-octylphosphocholine, n-dodecylphosphocholine, n-tetradecylphosphocholine, n-hexadecylphosphocholine, dimethylalkylbetaine, perfluoroalkylbetaine and lecithin.

It is possible to add, as a stabilizer, a substance capable of forming a hydrogen bond, for example, glycerol, polyhydric alcohol polyvinyl alcohol alkylamine and the like.

There is no particular limitation on a liquid medium for preparing an amphiphilic molecule-containing solution, as long as it can disperse carbon nanotube bundles in an isolated state by a combination with an amphiphilic molecule to be used. Examples thereof include aqueous solvents such as water, alcohol, and a combination thereof; and non-aqueous solvents (oil-based solvents) such as silicone oil, carbon tetrachloride, chloroform, toluene, acetone, and a combination thereof, and non-aqueous solvents are preferred.

The step of immersing in an amphiphilic molecule-containing solution is performed by immersing the entire aligned carbon nanotube base material in a container filled with an amphiphilic molecule-containing solution, together with a substrate, and then retaining a state for 30 minutes or more, preferably 2 hours or more, and more preferably 24 hours or more. There is no particular limitation on the temperature, and the temperature is preferably from 20° C. to 50° C., and more preferably from 25° C. to 40° C.

### <Drying Step>

Next, an aligned carbon nanotube base material is taken out from an amphiphilic molecule-containing solution and then dried.

Since a carbon nanotube has extremely high hydrophobicity, drying may be performed by natural drying. Preferably, a treatment is performed at a temperature which is 10 to 20° C. higher than a boiling point temperature of a solvent for 1 hour or more, and more preferably 4 hours or more, using a dryer.

<Step of Impregnating with Monomer>

Next, the dried aligned carbon nanotube base material is impregnated with a monomer.

It is possible to use, as the impregnation method, a known method as long as vertical alignment of carbon nanotubes on a substrate is retained. Specific examples thereof include a potting method, a casting method, a spin coating method, a dipping method, a spraying method and the like.

There is no particular limitation on the monomer, as long as it is a polymerizable monomer which is polymerized into a polymer.

The polymer includes, for example, a thermosetting resin (including a precursor), a thermoplastic resin, a photocurable resin, a thermoplastic elastomer, a rubber and the like, and is preferably a polymer having flexibility.

Specific examples of the polymer obtained from a monomer used in the present invention include thermosetting resins (including, a precursor) such as an epoxy resin, a thermosetting modified polyphenylene ether resin, a thermosetting polyimide resin, a urea resin, a crosslinking acrylic resin, an allyl resin, an unsaturated polyester resin, a silicone resin, a benzooxazine resin, a diallyl phthalate resin, a dicyclopentadiene resin, a phenol resin, a benocyclobutene resin, a bismaleimidetriazine resin, an alkyd resin, a furan resin, a melamine resin, a polyurethane resin and an aniline resin; thermoplastic resins such as a polyamide resin, a thermoplastic polyimide resin, a polyamideimide resin, a polyesterimide resin, a polyphenylene ether resin, a polystyrene resin, an alicyclic hydrocarbon resin, a polybenzooxazole resin, a polyether ether ketone (PEEK) resin, a polyethersulfone resin, a polycarbonate resin, a polyester resin, a polyolefin resin (various low-density to high-density polyethylenes, an isotactic polypropylene, an atactic polypropylene, a syndiotactic polypropylene, etc.), an ABS resin, a polyacrylonitrile resin, a polyvinyl acetal resin, a polyvinyl alcohol resin, a vinyl polyacetate resin, an acrylic resin, a polyoxymethylene resin and a silicone resin; rubbers such as a natural rubber, a urethane rubber, a silicone rubber, a butadiene rubber, an isoprene rubber, a styrene-butadiene copolymer rubber, a nitrile rubber, a hydrogenated nitrile rubber, a chloroprene rubber, an ethylene propylene rubber, a chlorinated polyethylene, a chlorosulfonated polyethylene, a butyl rubber, a halogenated butyl rubber and a fluorine-containing rubber; thermoplastic elastomers such as a TPO resin (olefin-based thermoplastic elastomer), a styrene-butadiene copolymer, a styrene-isoprene block copolymer, a hydrogenated styrene-butadiene, a hydrogenated styrene-isoprene block copolymer, a styrene-based thermoplastic elastomer, a polyurethane-based thermoplastic elastomer, a polyamide-based thermoplastic elastomer, a vinyl chloride-based thermoplastic elastomer and a polyester-based thermoplastic elastomer; photocurable resins such as a methoxymethylated nylon, a polyvinyl alcohol, a saturated polyester resin, a polyamide resin and a polybutadiene resin; and photocurable resins in which the above resins has a photocurable functional group. Polymers having flexibility are often suitable and, among these polymers, a polyimide resin, a polyamideimide resin, a room temperature vulcanizing (RTV) silicone rubber, a liquid rubber, a polyester resin and a polyurethane resin are preferred and a monomer constituting these polymers is preferably used. These monomers may be used alone, or two or more kinds of monomers may be used in combination.

Specific examples thereof include (meth)acrylic acid esters having a linear or branched skeleton structure, such as methyl (meth)acrylate, ethyl (meth)acrylate, 2-ethylhexyl (meth)acrylate, n-propyl (meth)acrylate, iso-propyl (meth)acrylate, n-butyl (meth)acrylate, iso-butyl (meth)acrylate, tert-butyl (meth)acrylate, methoxymethyl (meth)acrylate, n-propoxyethyl (meth)acrylate, iso-propoxyethyl (meth)acrylate, n-butoxyethyl (meth)acrylate, iso-butoxyethyl (meth)acrylate, tert-butoxyethyl (meth)acrylate, 2-hydroxyethyl (meth)acrylate, 3-hydroxy-n-propyl (meth)acrylate, 2-hydroxy-n-propyl (meth)acrylate, 4-hydroxy-n-butyl (meth)acrylate, 2-ethoxyethyl (meth)acrylate, 1-ethoxyethyl (meth)acrylate, 4-(meth)acryloyloxy-2-methyl-2-ethyl-1,3-dioxolane, 4-(meth)acryloyloxy-2-methyl-2-isobutyl-1,3-dioxolane, 4-(meth)acryloyloxy-2-cyclohexyl-1,3-dioxolane, tetrahydrofurfuryl (meth)acrylate, 2,2,2-trifluoroethyl (meth)acrylate, 2,2,3,3-tetrafluoro-n-propyl (meth)acrylate, 2,2,3,3-pentafluoro-n-propyl (meth)acrylate, cyclohexyl (meth)acrylate, isobornyl (meth)acrylate, adamantyl (meth)acrylate, tricyclodecanyl (meth)acrylate, dicyclopentadienyl (meth)acrylate, α-(tri)fluoromethyl acrylatemethyl ester, α-(tri)fluoromethyl acrylate ethyl ester, α-(tri)fluoromethyl acrylate 2-ethylhexyl ester, α-(tri)fluoromethyl acrylate-n-propyl ester, α-(tri)fluoromethyl acrylate-iso-propyl ester, α-(tri)fluoromethyl acrylate-n-butyl ester, α-(tri)fluoromethyl acrylate-iso-butyl ester, α-(tri)fluoromethyl acrylate-tert-butyl ester, α-(tri)fluoromethyl acrylate methoxymethyl ester, α(tri)fluoromethyl acrylate ethoxyethyl ester, α(tri)fluoromethyl acrylate-n-propoxyethyl ester, α-(tri)fluoromethyl acrylate-iso-propoxyethyl ester, α-(tri)fluoromethyl acrylate-n-butoxyethyl ester, α-(tri)fluoromethyl acrylate-iso-butoxyethyl ester and α-(tri)fluoromethyl acrylate tert-butoxyethyl ester; aromatic alkenyl compounds such as styrene, α-methylstyrene, vinyltoluene, p-hydroxystyrene, 3,5-di-tert-buytl-4-hydroxystyrene, 3,5-dimethyl-4-hydroxystyrene, p-tert-perfluorobutylstyrene and p-(2-hydroxy-iso-propyl)styrene; unsaturated carboxylic acids such as acrylic acid, methacrylic acid, maleic acid, maleic anhydride, itaconic acid and itaconic anhydride; and other monomers such as (meth)acrylonitrile, acrylamide, N-methylacrylamide, N,N-dimethylacrylamide, vinyl chloride, vinyl acetate, ethylene, vinyl fluoride, vinylidene fluoride, tetrafluoroethylene and vinylpyrrolidone. If necessary, these monomers can be used alone, or two or more kinds of monomers can be used in combination.

For example, polyethylene terephthalate (PET) can be prepared from terephthalic acid and ethylene glycol.

In the present invention, a solvent may be appropriately added to the monomer for the purpose of conversion of a solid state into a solution and adjustment of viscosity.

Examples of the solvent used in the monomer include aromatic hydrocarbon-based solvents such as toluene and xylene; aliphatic carboxylic acid ester-based solvents such as ethyl acetate and butyl acetate; aliphatic hydrocarbon-based solvents such as hexane, heptane and octane; ketone-based solvents such as acetone, methyl ethyl ketone and methyl isobutyl ketone; and so-called ionic liquids typified by water, various aqueous solutions, liquefied carbonic acid, ultracritical carbonic acid and methylimidazole. These solvents may be use alone, or two or more kinds of solvents may be used in combination.

Impregnation with a monomer is performed in the following manner.

(1) When it is requited for the end of a carbon nanotube on one surface of an aligned carbon nanotube base material to protrude from a polymer, or required tor the end of a carbon nanotube on both surfaces of an aligned carbon nanotube base material to protrude from a polymer, an aligned carbon nanotube base material is immersed in a container filled with a monomer solution such that tip of a carbon nanotube of an aligned carbon nanotube base material protrudes in a desired protrude length, taking a volume change from the water level of a monomer solution due to polymerisation.
(2) When the end of a carbon nanotube on both surfaces of an aligned carbon nanotube base material is not allowed to protrude from a polymer, the entire aligned carbon nanotube base material is immersed in a container filled with a monomer solution. Immediately after immersion, the treatment may be followed by a polymerization treatment. Preferably, the aligned carbon nanotube base material is impregnated with a monomer by retaining an immersed state for 30 minutes or more, and more preferably 2 hours or more.

When the end of a carbon nanotube on both surfaces of an aligned carbon nanotube base material is not allowed to protrude from a polymer, it is required that a polymerization treatment is once performed in the above state and a sheet is peeled from a substrate, and then a monomer is top-coated again on a substrate side, followed by polymerization.

### <Polymerization Step>

Next, a monomer, with which an aligned carbon nanotube base material is impregnated, is polymerized to form a carbon nanotube sheet, in which the space between carbon nanotubes is filled with a polymer, on a substrate.

Radical polymerization, cationic polymerization, anionic polymerization, ionic polymerization, ring-opening polymerization, elimination polymerization, polyaddition reaction and polycondensation reaction are used as polymerization reaction, and there is no particular limitation.

Specifically, it is possible to exemplify a direct esterification method in which a polyester is directly synthesized from two molecules of ethylene glycol and terephthalic acid, and melt polycondensation reaction in which a polyester is synthesized by heating bishydroxyethyl terephthalate synthesized from the above two molecules 270° C. or higher in vacuum.

After the polymerization step, the molding step of molding by heat drying, heat curing and/or light irradiation.

The molding step by heat drying means that the polymerized polymer is subjected to a heat treatment without causing a crosslinking reaction or a curing reaction. Such a treatment enables the production of a carbon nanotube sheet having improved physical properties such as heat resistance, solvent resistance and elasticity.

The molding step by heat curing means that the polymerized polymer is subjected to a heat treatment by a crossliking reaction or curing reaction. Such a treatment enables the production of a sheet having improved physical properties such as heat resistance, solvent resistance and elasticity by a thermosetting reaction or a thermal crosslinking reaction to form a three-dimensional network structure while increasing a molecular weight.

The molding step by light irradiation means that the polymerized polymer is subjected to a light irradiation treatment by a photocrossliking reaction or a photocuring reaction. Such a treatment enables the production of a sheet having improved physical properties such as heat resistance, solvent resistance and elasticity by a thermosetting reaction or a thermal crosslinking reaction to form a three-dimensional network structure while increasing a molecular weight.

These molding steps may be performed alone, or two or three kinds of molding steps may be performed in combination.

### <Peeling Step>

Next a carbon nanotube sheet in which the space between carbon nanotubes is filled with a polymer is peeled front a substrate.

In the peeling step, a carbon nanotube sheet can be peeled as it is, immediately after a polymerization treatment. More preferably, when peeling is performed in a solution such as ion-exchange water, it is possible to prevent the carbon nanotube sheet from breaking during peel to cause fracture.

The peeling step may also be performed by applying a pressure sensitive adhesive tape having a weak adhesive power to a carbon nanotube sheet on a substrate, followed by peeling.

In the peeling step, peeling may be performed after decreasing a bond between a substrate and a carbon nanotube sheet by vibrating an aligned carbon nanotube base material.

These carbon nanotube sheets may be used alone, or two or more kinds of carbon nanotube sheets may be used by lamination. When two or more kinds of carbon nanotube sheets are used by lamination, an adhesive layer or a binder layer may be appropriately provided between sheets.

If necessary, the surface of the carbon nanotube sheet may be appropriately subjected to mold release and antifouling treatments using a silicone-, fluorine-, long chain alkyl- or fatty acid amide-based releasant, or a silica powder; easy adhesion treatments such as an acid treatment, an alkali treatment, a primer treatment, an anquor coat treatment, a corona treatment, a plasma treatment and an ultraviolet ray treatment; mold release treatments such as a hard coat treatment; and coating-, kneading- and deposition-type antistatic treatments.

### [Second Method for Production of Carbon Nanotube Sheet]

A second method for producing a carbon nanotube sheet of the present invention will be described in detail.

A difference between the first method for producing a carbon nanotube sheet and the second method for producing a carbon nanotube sheet is in that the step of drying an aligned carbon nanotube base material is not included; the aligned carbon nanotube base material is made to be present in a vertically downward stat in the step of impregnating an aligned carbon nanotube base material with a monomer; and the aligned carbon nanotube base material is prevented from drying in a range from immersion in the amphiphilic molecule-containing solution to impregnation with the monomer.

In the second method for producing a carbon nanotube sheet, an aligned carbon nanotube base material is immersed in an amphiphilic molecule-containing solution, washed, with a washing solvent, and then the aligned carbon nanotube base material is made to be present in a vertically downward state while preventing the aligned carbon nanotube base material from drying. Then, the aligned carbon nanotube base material is impregnated with a monomer while retaining this state. Such an operation enables prevention of carbon nanotubes vertically aligned from collapsing on a substrate.

Examples of the washing solvent include an ion-exchange water and pure wafer. Since a carbon nanotube has very high hydrophobicity, it is rapidly followed by the step of immersing in a monomer after the washing step so as to prevent drying.

Usually, when an aligned carbon nanotube base material is immersed in an amphiphilic molecule-containing solution, a bundle of carbon nanotubes is opened, and also a dispersing agent sued as amphiphilic molecule and a solvent are adhered onto this carbon nanotube. Accordingly, when carbon nanotubes are dried in this state, it becomes impossible to perform vertical alignment of carbon nanotubes by the weight of carbon nanotubes and surface tension of the solvent, and thus carbon nanotubes may collapse on a substrate. When vertical alignment is broken, permeability of a monomer into an aligned carbon nanotube base material deteriorates. Such a defect drastically arises when the carbon nanotube on the substrate has low density.

An object of a second method for producing a carbon nanotube sheet is to prevent the above defect.

When the aligned carbon nanotube base material is impregnated with a monomer, it is preferred to provide a spacer having a thickness of several hundreds μm to several mm on a container filled with a monomer solution so as to prevent carbon nanotubes from collapsing by pressing against the bottom of the container.

### EXAMPLES

The present invention will be specifically described below by way of examples. It should be understood that these are exemplary of the invention and are not to be considered as limiting.

### Example 1

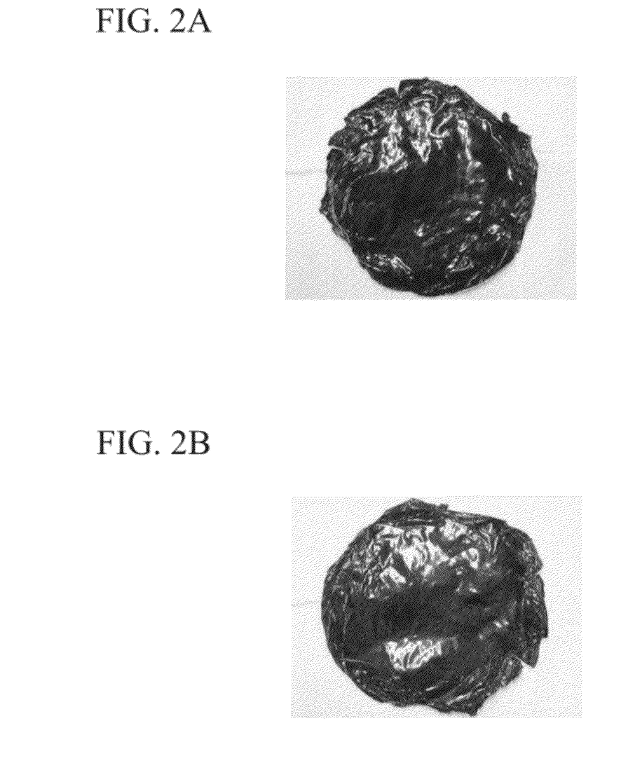

An example of a carbon nanotube sheet produced by applying a first method, for producing a carbon nanotube sheet of the present invention is shown in FIG. 2A and FIG. 2B.

This carbon nanotube sheet is produced on a 6 inch (15 cm) silicon substrate with an oxide film. It is apparent that a polymer penetrates into the entire surface of a highly aligned carbon nanotube, and thus succeeding in complete (100%) peeling and transfer of the highly aligned carbon nanotube grown on the silicon substrate.

The carbon nanotube sheet of Example 1 was produced by the following procedure.

### <Step of Producing Aligned Carbon Nanotube Base Material>

(1) An iron catalyst was deposited in a thickness of 4.0 nm on a 6 inch silicon substrate with an oxide film by sputtering.
(2) He (100%) was introduced into a reactor made of quartz, and the silicon substrate was heated to 700° C. by an infrared heater under an inert atmosphere.
(3) When the temperature of the silicon substrate reaches 700° C., C₂H₂ was introduced into the reactor made of quartz so as to attain the composition C₂H₂:He=46:54, and then a CVD treatment was performed for 2 minutes.
(4) As a result of (1) to (3), a highly aligned carbon nanotube A (aligned carbon nanotube base material) having a total weight of 68 mg and a height of 150 μm was obtained on a silicon substrate.

### <Step of Immersing in Amphiphilic Molecule-Containing Solution and Drying Step>

(1) To 300 cc of an aqueous sodium iodide solution having the concentration of 1.0 mmol, 3.4 g (50 times more than the amount of the highly aligned carbon nanotube A) of 3-([3-cholamidepropyl)dimethylammonio]propane sulfonate (CHAPS) as an amphiphilic surfactant was added, and a dispersion treatment was performed for 10 minutes by an ultrasonic homogenizer (BRANSON SONIFIER, 450.20 kHz) to prepare a dispersion solution B.
(2) A rectangular container (measuring 30 cm in length, 17 cm in width find 5 cm in depth) made of stainless steel was filled with the dispersion solution B and the highly aligned carbon nanotube A was immersed in the dispersion solution B, together with a substrate. This rectangular container was placed in a vacuum dryer (Vacuum Dryer DP32, manufactured by Yamato Scientific Co., Ltd.), evacuated to −73 mmHgG while maintaining at room temperature (normal temperature of about 25° C.) and then allowed to stand for 2 hours.

(3) Thereafter, a preset temperature of the vacuum dryer was set to 120° C. and a state was maintained for 4 hours, and then the highly aligned carbon nanotube A and the dispersion solution B were subjected to a drying treatment.

(4) The preset temperature of the vacuum dryer was set to normal temperature and the pressure was set to an atmospheric pressure to obtain an isolated dispersed highly aligned carbon nanotube C.
<Step of Impregnating with Monomer>
(1) Ethylene glycol was mixed with terephthalic acid in a molar ratio of 1.6:1.0 to prepare 300 cc of a monomer solution D, and a rectangular container made of stainless steel (measuring 30 cm in length, 17 cm in width and 3 cm in depth) was filled with the monomer solution D.
(2) The isolated dispersed highly aligned carbon nanotube C was immersed in the monomer solution D in the rectangular container made of stainless steel, together with a substrate, such that tip of the highly aligned carbon nanotube slightly protrudes from the water surface of the solution. This rectangular container was placed in a vacuum dryer and a reaction treatment was performed under a pressure of −73 mmHgG at a temperature of 255° C. for 2 hours to obtain a highly aligned carbon nanotube E impregnated with an oligomer containing bishydroxyethyl terephthalate as a main component.

### <Polymerization Step>

(1) To the highly aligned carbon nanotube E impregnated with an oligomer containing bishydroxyethyl terephthalate as a main component, antimony trioxide as a polycondensation catalyst was added in the amount of 100 ppm based on the number of moles of terephthalic acid, and a reaction treatment was performed under a pressure of −73 mmHgG at a temperature of 275° C. for 4 hours.
(2) The rectangular container made of stainless steel was taken out from the vacuum dryer and the surplus molten polymer was removed to obtain a highly aligned carbon nanotube F in which the space between carbon nanotubes is filled with a polyester.

### <Peeling Step>

(1) After the silicon substrate was sufficiently cooled, the highly aligned carbon nanotube F filled with the polyester was peeled from the silicon substrate to obtain a polymer transfer film G (carbon nanotube sheet) made of highly aligned carbon nanotubes.

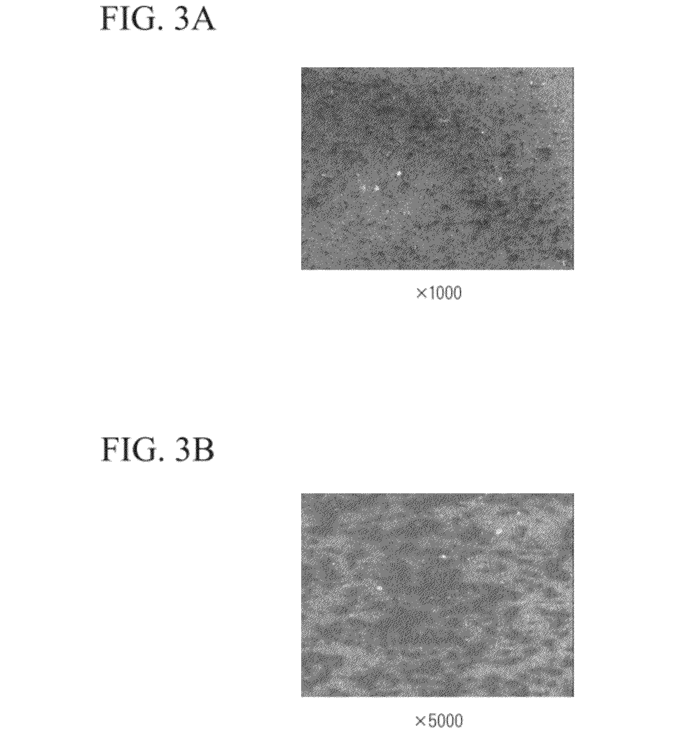

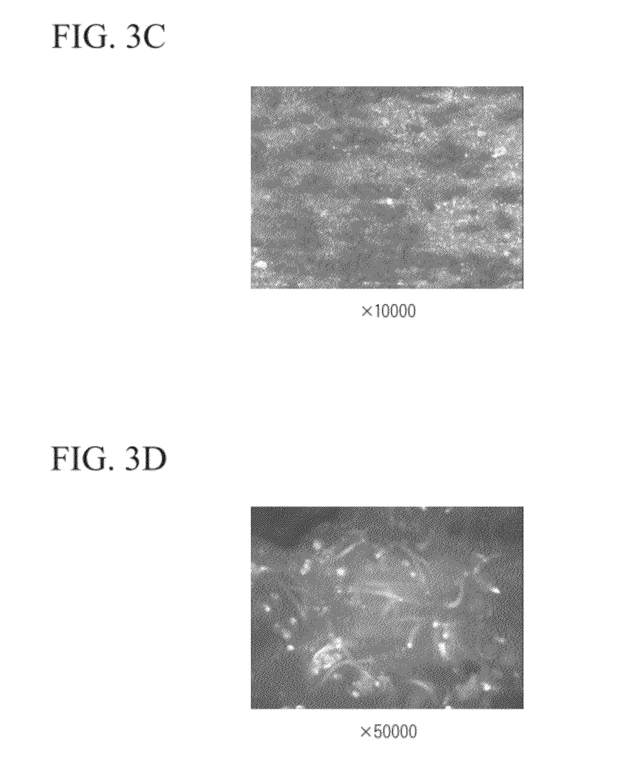

Electron microscope (FE-SEM) (JSM-6700F (3.0 kV), manufactured by JEOL Ltd.) photographs of a carbon nanotube sheet shown In FIG. 2A and FIG. 2B are shown in FIG. 3A to FIG. 3D.

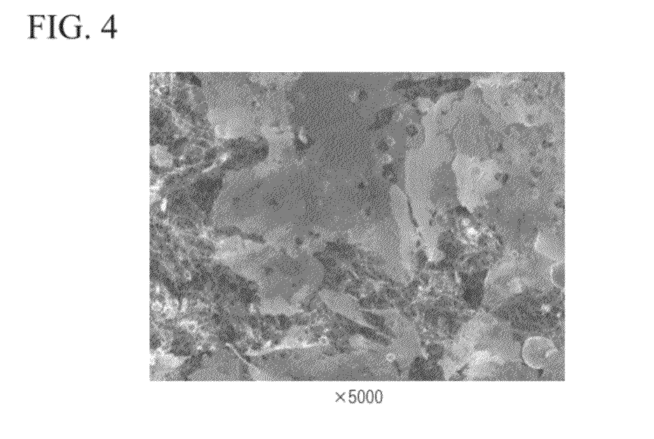

An electron microscope (FE-SEM) photograph of a carbon nanotube sheet produced by a conventional method as Comparative Example is shown in FIG. 4.

The carbon nanotube sheet of Comparative Example was produced by the following procedure.

(1) The highly aligned carbon nanotube A produced by the same procedure as in <Step of Producing Aligned Carbon Nanotube Base Material> of the above Example was cut into pieces of 1 cm×2 cm in size (carbon nanotube H).
(2) TFW-3000 (having an average particle diameter of 5 μm manufactured by Seishin Enterprise Co., Ltd,) as a highly recycled PTFE (polytetrafluoroethylene) which has a molecular weight (about 10,000) smaller than that of a conventional fluorine resin (having a molecular weight of several hundreds of thousands) and also has fluidity, was spread over an ash tray (measuring 3 cm×6 cm×5 mm in depth) made of glass, and then carbon nanotubes H were disposed such that aligned faces of carbon nanotubes face toward a direction (downward) for contact with PTFE.
(3) A stone weight of 2 kg was placed from rear surfaces of a substrate of carbon nanotubes H.
(4) The carbon nanotubes H were disposed in vacuum substitution electric furnace (TVS-200-200-400, manufactured by Tokai Konetsu Kogyo Co., Ltd.), together with the ash tray. After adjusting to high vacuum condition of 10 Pa, heating was carried out at 360° C., which is a melting point of PTFE (TFW-3000), for 4 hours.
(5) The peeling step was performed by the same procedure as in <Peeling Step> of the above Example, a carbon nanotube sheet of Comparative Example was obtained by peeling from a silicon substrate.

As is apparent from the SEM photograph in FIG. 4, PTFE is only accumulated on a surface of highly aligned carbon nanotubes and carbon nanotubes are separated from PTFE, and thus the space between highly aligned carbon nanotubes is not filled with PTFE in a carbon nanotube sheet of Comparative Example.

It could be confirmed that PTFE is not sufficiently filled in appearance and SEM observation reveals insufficient filling in a conventional carbon nanotube sheet.

In contrast, as is apparent from SEM photographs shown in FIG. 3A to FIG. 3D, the space between highly aligned carbon nanotubes is filled with a polyester in a carbon nanotube sheet of the present invention. A single carbon nanotube is observed in the SEM photograph at 50,000 times magnification shown in FIG. 3D.

It could be continued that the space in a single carbon nanotube is filled with a polyester in a carbon nanotube sheet of the present invention.

### Example 2

An example of a carbon nanotube sheet produced by applying a second method for producing a carbon nanotube sheet of the present invention is shown. The carbon nanotube sheet of Example 2 was produced by the following procedure.

### <Step of Producing Aligned Carbon Nanotube Base Material>

A highly aligned carbon nanotube A (aligned carbon nanotube base material) was obtained by the same procedure as in Example 1.

### <Step of Immersing in Amphiphilic Molecule-Containing Solution and Cleaning Step>

(1) To 300 cc of an aqueous sodium iodide solution having the concentration of 1 mmol, 3.4 g (50 times more than the amount of the highly aligned carbon nanotube A) of 3-[(3-cholamidepropyl)dimethylammonio]propane sulfonate (CHAPS) as an amphiphilic surfactant was added, and a dispersion treatment was performed for 10 minutes by an ultrasonic homogenizer (ULTRASONIC HOMOGENIZER UH-50, 50 W 20 kHz, manufactured by SMT Corporation) to prepare a dispersion solution B.
(2) A fluorine-coated rectangular container (measuring 30 cm in length, 17 cm in width and 5 cm in depth) was filled with a dispersion solution B and the highly aligned carbon nanotube A was immersed in the dispersion solution B, together with a substrate. At this time, the substrate was disposed in a vertically upward state. This rectangular container was placed in a vacuum thermostatic bath and then left to stand under vacuum at 36° C. for 24 hours. By this step, an isolated dispersed highly aligned carbon nanotube C was obtained.
(3) Thereafter, the highly aligned carbon nanotube C was washed with ion-exchange water, followed by the step of impregnating with a monomer before the highly aligned carbon nanotube C is dried.
<Step of Impregnating with Monomer>
(1) Ethylene glycol was mixed with terephthalic acid in a molar ratio of 1.6:1.0 to prepare 300 cc of a monomer solution D, and a rectangular container made of stainless steel (measuring 30 cm in. length, 17 cm in. width, and 5 cm in depth) was filled with the monomer solution D. Within a diameter of 150 cm of the bottom of the rectangular container, a spacer having a thickness of 600 μm was provided at four positions.
(2) The highly aligned carbon nanotube C was immersed in the monomer solution D in the rectangular container, together with a substrate. At this time, the substrate was disposed on the above spacer in a vertically downward state. This rectangular container was placed in a vacuum dryer and a reaction treatment was performed under a pressure of −73 mmHgG at a temperature of 255° C. for 2 hours to obtain a highly aligned carbon nanotube E impregnated with an oligomer containing bishydroxymyethyl terephthalate as a main component.

### <Polymerization Step>

(1) To the highly aligned carbon nanotube E impregnated with an oligomer containing bishydroxyethyl terephthalate as a main component, antimony trioxide as a polycondensation catalyst was added in the amount of 100 ppm based on the number of moles of terephthalic acid, and a reaction treatment was performed under a pressure of −73 mmHgG at a temperature of 275° C. for 4 hours.
(2) The rectangular container was taken out from the vacuum dryer and the surplus molten polymer was removed to obtain a highly aligned carbon nanotube F in which the space between carbon nanotubes is filled with a polyester.

### <Peeling Step>

A polymer transfer film G (carbon nanotube sheet) was obtained by the same procedure as in Example 1.

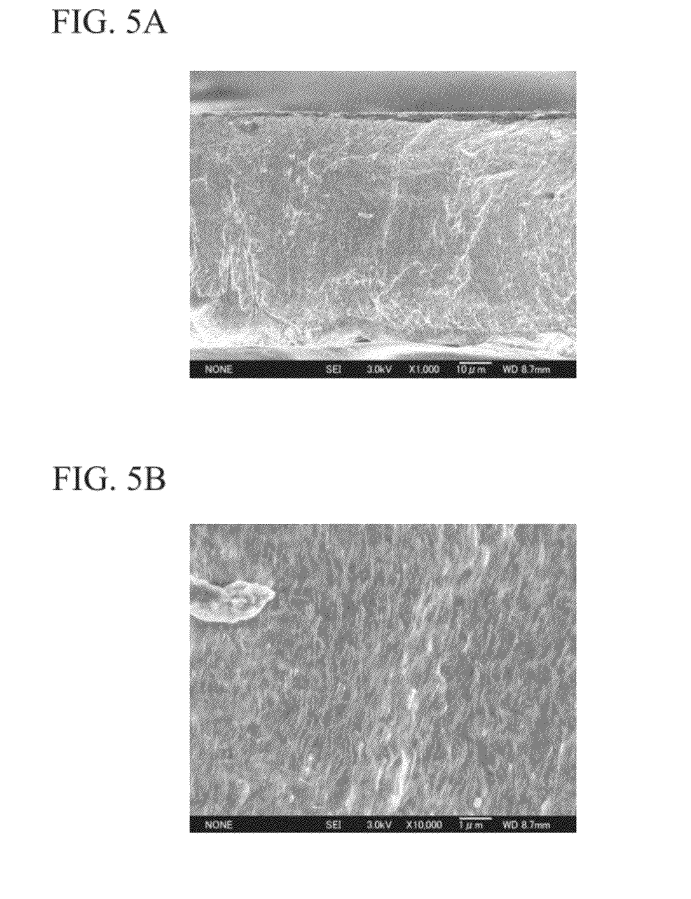

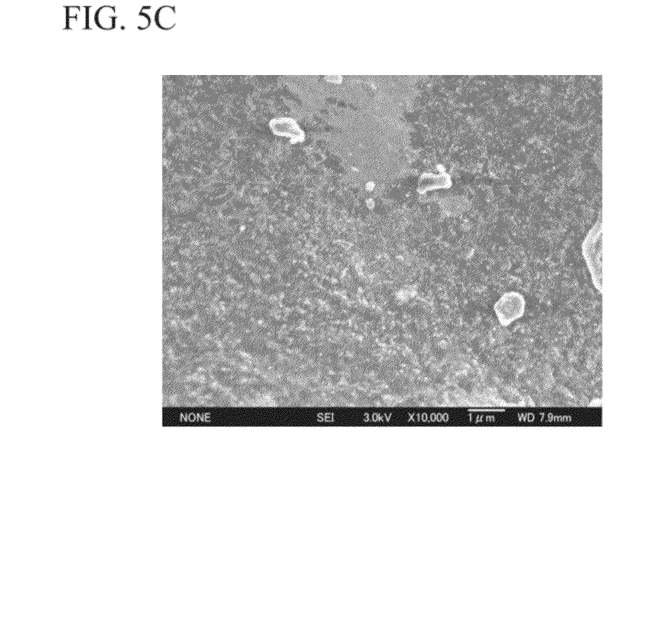

Electron microscope (FE-SEM) JSM-6700F (3.0 kV), manufactured by JEOL Ltd.) photographs of a carbon nanotube sheet obtained in Example 2 are shown in FIG. 5A. to FIG. 5C. As is apparent from these SEM photographs, the highly aligned carbon nanotube satisfactory retains vertical alignment in a carbon nanotube sheet of the present invention. In particular, as is apparent from FIG. 5A, the obtained highly aligned carbon nanotube has a height of about 100 μm or more. As is apparent from FIG. 5B and FIG. 5C, a polymer satisfactorily penetrates into the space between highly aligned carbon nanotubes, and thus contributing to retention of vertical alignment.

### INDUSTRIAL APPLICABILITY

The carbon nanotube sheet of the present invention can be used as a substrate of displays such as a liquid crystal display (LCD), an organic electroluminescence display (organic ELD) and a field emission display (FED) by using as an anisotropic conductive sheet. The carbon nanotube sheet of the present invention can be utilized as an electrode material of a fuel battery, a Li ion battery and the like by using a carbon nanotube transfer film having high density and high aspect ratio.

1. A carbon nanotube sheet comprising carbon nanotubes and a polymeric material, wherein
the carbon nanotubes are present in an isolated state,
the axis directions of the carbon nanotubes are aligned in a thickness direction of the carbon nanotube sheet, and
the space between the carbon nanotubes is filled with the polymeric material.

2. The carbon nanotube sheet according to claim 1, wherein the end of the carbon nanotube protrudes from a front surface and/or a rear surface of the carbon nanotube sheet.

3. The carbon nanotube sheet according to claim 1, wherein the end of the carbon nanotube is embedded in the polymeric material, and the carbon nanotube does not protrude from any of front and rear surfaces of the carbon nanotube sheet.

4. The carbon nanotube sheet according to claim 1, wherein the occupancy of a carbon nanotube in a plane direction of the carbon nanotube sheet is 0.001% or more.

5. The carbon nanotube sheet according to claim 1, wherein a ratio ρₗ/ρₜ of volume resistivity (ρₗ) in a thickness direction to volume resistivity (ρₜ) in a plane direction of the carbon nanotube sheet is 50 or more.

6. The carbon nanotube sheet according to claim 1, wherein the carbon nanotube has a length of 10 μm or more.

7. The carbon nanotube sheet according to claim 6, wherein the thickness of the polymeric material filled accounts for 0.5% to 150% of the length of the carbon nanotube.

8. A method for producing a carbon nanotube sheet, which comprises:
immersing an aligned carbon nanotube base material including a substrate, and the group of carbon nanotubes in which a plurality of carbon nanotubes are vertically aligned in the form of a bundle to the substrate, in an amphiphilic molecule-containing solution;
drying the immersed aligned carhop nanotube base material;
impregnating the dried aligned carbon nanotube base material with a monomer;
polymerizing the monomer thereby to form a carbon nanotube sheet, in which the space between carbon nanotubes is filled with the polymer, on the substrate; and
peeling the carbon nanotube sheet from the substrate.

9. A method for producing a carbon nanotube sheet, which comprises:
immersing an aligned carbon, nanotube base material including a substrate, and the group of carbon nanotubes in which a plurality of carbon nanotubes are vertically aligned in the form of a bundle to the substrate, in an amphiphilic molecule-containing solution;
washing the aligned carbon nanotube base material with a washing solvent;
impregnating the aligned carbon nanotube base material, which is made to be present in a vertically downward state, with a monomer;
polymerizing the monomer thereby to form a carbon nanotube sheet on the substrate; and
peeling the carbon nanotube sheet from the substrate; wherein
the aligned carbon nanotube base material is prevented from drying in a range from immersion in the amphiphilic molecule-containing solution to impregnation with the monomer.

10. The method for producing a carbon nanotube sheet according to claim 8, wherein the amphiphilic molecule is selected from the group consisting of a polymer of 2-methacryloyloxyethylphosphorylcholine, polypeptides, 3-(N,N-dimethylstearylammonio)propane sulfonate, 3-(N,N-dimethylmyristylammonmio)propane sulfonate, 3-[(3-cholamidepropyl)dimethylammonio]-1-propane sulfonate (CHAPS), 3-[(3-cholamidepropyl)dimethylammonio]-2-hydroxypropane sulfonate (CHAPSO), n-dodecyl-N,N′-dimethyl-3-ammonio-1-propane sulfonate, n-hexadecyl-N,N′-dimethyl-3-ammonio-1-propane sulfonate, n-octylphosphocholine, n-dodecylphosphocholine, n-tetradecylphosphocholine, n-hexadecylphosphocholine, dimethylalkylbetaine, perfluoroalkylbetaine and lecithin.

11. The method for producing a carbon nanotube sheet according to claim 8, wherein the occupancy of vertically aligned carbon nanotubes in a plane direction of the aligned carbon nanotube base material is 0.001% or more.
